(19) United States
(12) Patent Application Publication
(10) Pub. No.: US 2025/0337198 A1
(43) Pub. Date: Oct. 30, 2025

(54) CONTACT WAFER FOR A CONNECTOR ASSEMBLY HAVING A SIGNAL CONDITIONING MODULE

(71) Applicant: TE Connectivity Solutions GmbH, Schaffhausen (CH)

(72) Inventor: Brian Patrick Costello, Athens, GA (US)

(21) Appl. No.: 18/644,308

(22) Filed: Apr. 24, 2024

(51) Int. Cl. H01R 13/6471; H01R 12/72; H01R 13/514; H01R 13/6587

(52) U.S. Cl. CPC H01R 13/6471; H01R 12/727; H01R 13/514; H01R 13/6587

(57) ABSTRACT

An electrical connector assembly includes a connector housing holding contact wafers arranged in a contact wafer stack. Each contact wafer includes a wafer frame, a contact assembly coupled to the wafer frame, and a signal conditioning module coupled to the wafer frame. The signal conditioning module includes a circuit board and a repeater device mounted to the circuit board. The contact assembly includes signal contacts forming data channels. The signal contacts have mating ends and terminating ends. The terminating ends are electrically connected to the circuit board of the signal conditioning module. The data channels are electrically connected to the repeater device through the circuit board. The repeater device is configured to restore signals transmitted along the data channels.

### BACKGROUND OF THE INVENTION

The subject matter herein relates generally to connector assemblies.

Some electrical systems utilize electrical connector assemblies to interconnect various electrical components, such as of a motherboard and daughtercard. High speed electrical connector assemblies suffer from problems with cross talk and can exhibit signal degradation, such as along long signal traces on circuit boards. As systems signal speeds increase, the data path generally needs to improve accordingly or the length of the data path needs to decrease. Some communication systems make use of active signal conditioning components in the data path. An optimal location for the active signal conditioning component is generally in the middle of the data path which is often located within the backplane and midplane. For a variety of reasons, it is not generally feasible to incorporate active components on backplanes, mid planes, or cable backplanes. Rather, it is commonplace such components on removable daughter cards as close to the interface connectors as possible. However, the removable daughter cards take up significant circuit board area and often require significant distance to be wasted along the data paths since the number of chips that can be located directly adjacent the connectors is limited. Moreover, dissipation of heat generated by the active components is difficult and further occupies additional space around the connectors.

A need remains for cost effective and reliable electrical connectors having improved electrical performance.

### BRIEF DESCRIPTION OF THE INVENTION

In one embodiment, an electrical connector assembly is provided and includes a connector housing that has housing walls forming a chamber. The electrical connector assembly includes contact wafers arranged in a contact wafer stack. The contact wafers are received in the chamber and coupled to the connector housing. Each contact wafer includes a wafer frame, a contact assembly coupled to the wafer frame, and a signal conditioning module coupled to the wafer frame. The signal conditioning module includes a circuit board and a repeater device mounted to the circuit board. The contact assembly includes signal contacts forming data channels. The signal contacts have mating ends and terminating ends. The mating ends configured to be mated to mating contacts of a mating connector assembly. The terminating ends are electrically connected to the circuit board of the signal conditioning module. The data channels are electrically connected to the repeater device through the circuit board. The repeater device is configured to restore signals transmitted along the data channels.

In another embodiment, an electrical connector assembly is provided and includes a connector housing that has housing walls forming a chamber. The electrical connector assembly includes contact wafers arranged in a contact wafer stack. The contact wafers are received in the chamber and coupled to the connector housing. Each contact wafer includes a wafer frame, a contact assembly coupled to the wafer frame, a signal conditioning module coupled to the wafer frame, and a cable assembly terminated to the signal conditioning module. The contact assembly is electrically connected to the cable assembly through the signal conditioning module. The signal conditioning module includes a circuit board and a repeater device mounted to the circuit board. The contact assembly includes signal contacts. The signal contacts have mating ends and terminating ends. The mating ends configured to be mated to mating contacts of a mating connector assembly. The terminating ends are electrically connected to the circuit board of the signal conditioning module. The signal contacts are electrically connected to the repeater device through the circuit board. The cable assembly includes cables terminated to the circuit board. The cables are electrically connected to the repeater device through the circuit board. The cables and the corresponding signal contacts form data channels. The repeater device is configured to restore signals transmitted along the data channels.

In a further embodiment, an electrical connector assembly is provided and includes a connector housing that has housing walls forming a chamber. The electrical connector assembly includes contact wafers arranged in a contact wafer stack. The contact wafers are received in the chamber and coupled to the connector housing. Each contact wafer includes a wafer frame, a contact assembly coupled to the wafer frame, a signal conditioning module coupled to the wafer frame, and a shell surrounding the wafer frame and the signal conditioning module. The signal conditioning module includes a circuit board and a repeater device mounted to the circuit board. The contact assembly includes signal contacts forming data channels. The signal contacts have mating ends and terminating ends. The mating ends configured to be mated to mating contacts of a mating connector assembly. The terminating ends are electrically connected to the circuit board of the signal conditioning module. The data channels are electrically connected to the repeater device through the circuit board, wherein the repeater device is configured to restore signals transmitted along the data channels. The shell is thermally conductive. The shell is thermally coupled to the repeater device to dissipate heat from the repeater device.

### BRIEF DESCRIPTION OF THE DRAWINGS

FIG. 1 is a perspective view of an exemplary embodiment of an electrical connector system illustrating a first connector assembly and a second connector assembly that may be directly mated together.

FIG. 2 is an exploded view of one of the contact wafers in accordance with an exemplary embodiment.

FIG. 3 is an exploded view of a portion of the contact wafer showing the wafer frame, the signal contacts and the signal conditioning module in accordance with an exemplary embodiment.

FIG. 4 is a perspective view of a side of the signal conditioning module in accordance with an exemplary embodiment.

FIG. 5 is a perspective view of a side of the signal conditioning module showing the cables of the cable assembly configured to be electrically connected to the signal conditioning module in accordance with an exemplary embodiment.

FIG. 6 is an exploded view of the first connector assembly in accordance with an exemplary embodiment.

FIG. 7 is a bottom perspective view of the first connector assembly in accordance with an exemplary embodiment.

FIG. 8 is a sectional view of the first connector assembly in accordance with an exemplary embodiment.

FIG. 9 is a front perspective view of the first connector assembly in accordance with an exemplary embodiment showing a first arrangement of the heat transfer elements.

FIG. 10 is a front perspective view of the first connector assembly in accordance with an exemplary embodiment showing a second arrangement of the heat transfer elements.

FIG. 11 is an exploded view of the first connector assembly in accordance with an exemplary embodiment showing one of the contact waivers poised for loading into the connector housing and showing the ground contacts configured to be electrically connected to the contact waivers and the circuit board.

FIG. 12 is an exploded view of one of the contact waivers configured to be connected to the circuit board in accordance with an exemplary embodiment.

FIG. 13 is a rear perspective, partial sectional view of the first connector assembly in accordance with an exemplary embodiment.

### DETAILED DESCRIPTION OF THE INVENTION

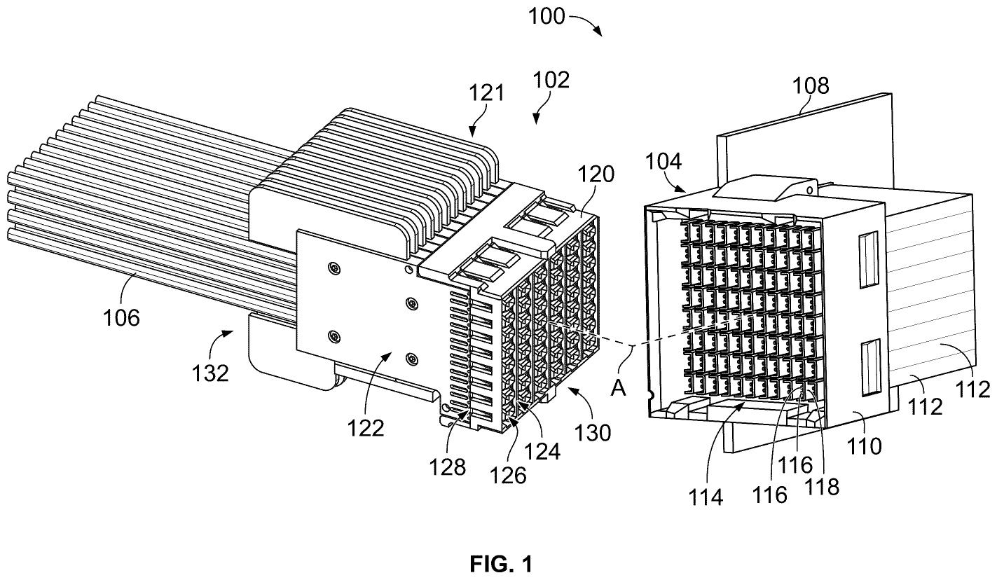

FIG. 1 is a perspective view of an exemplary embodiment of an electrical connector system 100 illustrating a first connector assembly 102 and a second connector assembly 104 that may be directly mated together. The first connector assembly 102 and/or the second connector assembly 104 may be referred to hereinafter individually as a “connector assembly” or collectively as “connector assemblies”. The connector assemblies 102, 104 are electrical connector assemblies, such as high speed data communication connectors. The connector assemblies 102, 104 may be considered mating electrical connectors or mating connector assemblies of each other having complimentary mating interfaces. In the illustrated embodiment, the first connector assembly 102 is a plug connector and the second connector assembly 104 is a receptacle connector.

The first connector assembly 102 and/or the second connector assembly 104 may be a board mounted connector assembly. The first connector assembly 102 and/or the second connector assembly 104 may be a cable connector assembly. In the illustrated embodiment, the first connector assembly 102 is a cable connector assembly electrically connected to cables 106 and the second connector assembly 104 is a board connector assembly electrically connected to a circuit board 108. The first and second connector assemblies 102, 104 are electrically connected at a separable mating interface. A mating axis A extends through the first and second connector assemblies 102, 104. The first and second connector assemblies 102, 104 are mated together in a direction parallel to and along the mating axis A. For example, the mating end of the first connector assembly 102 may be plugged into a receptacle at the mating end of the second connector assembly 104.

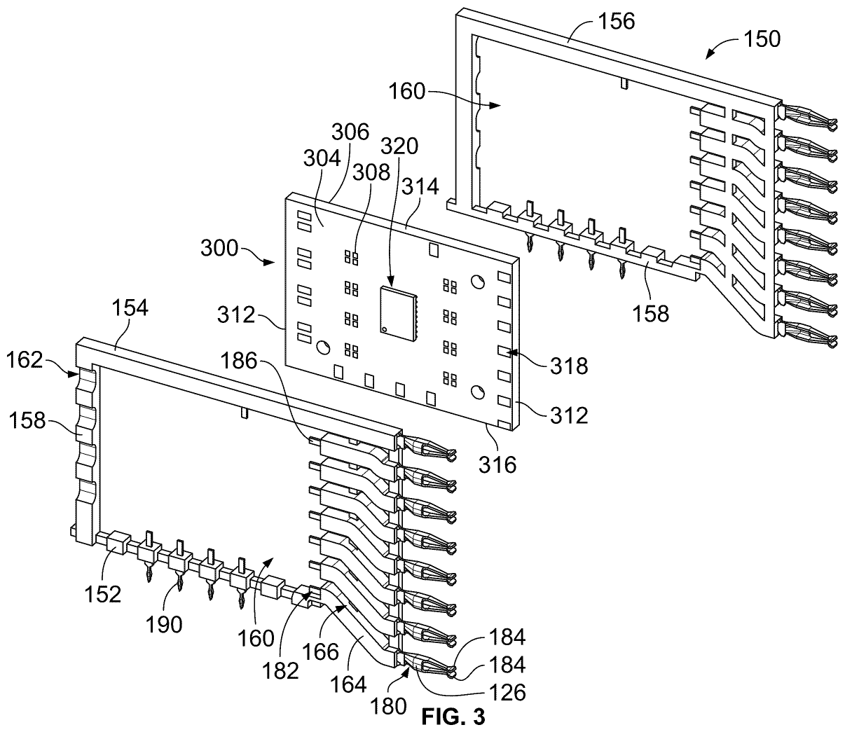

The first connector assembly 102 includes a connector housing 120 that holds a plurality of contact wafers 122 arranged in a contact wafer stack 121. Any number of contact wafers 122 may be provided in the contact wafer stack 121 to increase the signal pin count of the first connector assembly 102. The contact wafers 122 each include a contact assembly 124. The contact assembly 124 includes a plurality of signal contacts 126 (shown in FIG. 3) that are received in the connector housing 120 for mating with the second connector assembly 104. The contact assembly 124 may include one or more leadframes of stamped and formed contacts. The signal contacts 126 are electrically connected to conductors of corresponding cables 106 forming data channels through the first connector assembly 102 to allow data communication between various components of the communication system.

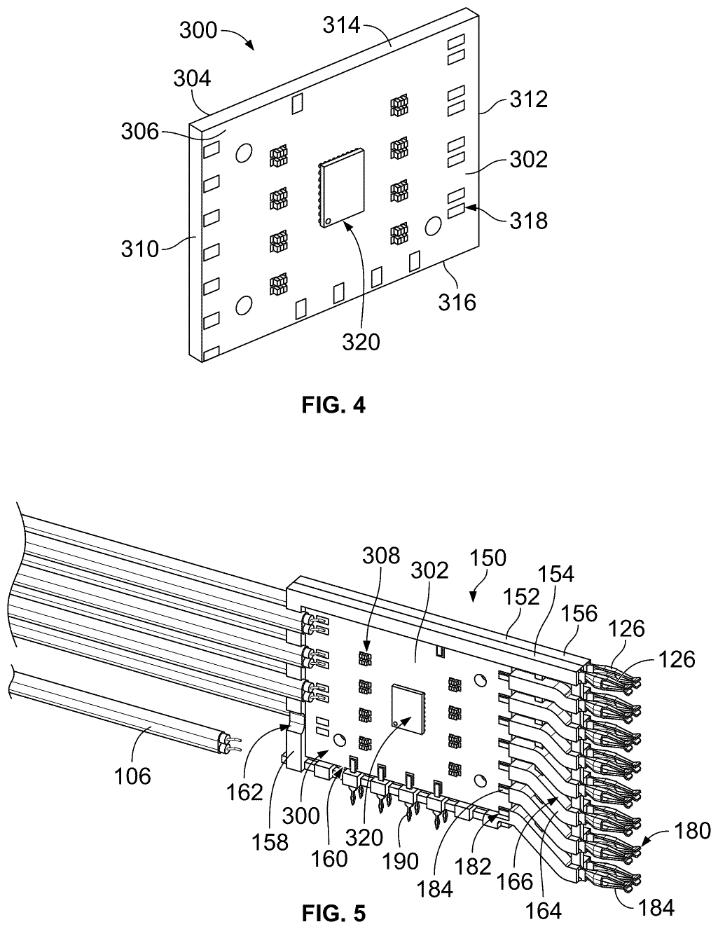

In an exemplary embodiment, each contact wafer 122 includes a signal conditioning module 300 (FIG. 4) for conditioning the signals transmitted along the data channels. The signal conditioning module 300 may amplify the signals and/or retransmit the signals. For example, the signal conditioning module 300 may include one or more active components, such as repeater devices, to restore signals transmitted along the data channels. The signal conditioning module 300 may condition the signals by providing equalization functions, such as to compensate for jitter and in turn transmit a conditioned signal downstream. The signal conditioning module 300 is strategically placed along the data channels, such as near the interface between the electrical connectors 102, 104, to meet budget constraints on the data channels. The signal conditioning module 300 operates as a channel reach extension device to extend the transmission line length along the data channels. For example, when the channel length of the data channel between the various electrical components of the communication system is longer than an allowable channel length, such as per protocol specifications, the signal conditioning module 300 restores the signals by passing the data channels through the signal conditioning module 300. The signal conditioning module 300 allows reliable, error-free communication for the communication system. The signal conditioning module 300 is configured to restore the signals at some point midway between the end points (for example, the various electrical components in the communication system). The signal conditioning module 300 are incorporated into the contact wafers 122 to avoid the need for mounting additional components onto a circuit board within the communication system, thus shortening the data channels and eliminating costly components and physical space within the system. The signal conditioning module 300 is positioned within the system at locations for active or passive cooling of the components.

In an exemplary embodiment, the signal contacts 126 are arranged in pairs defining differential pairs. In the illustrated embodiment, the pairs of signal contacts 126 are arranged in rows defining a pair-in-row connector interface. In alternative embodiments, the pairs of signal contacts 126 may be arranged in columns defining a pair-in-column connector interface.

In an exemplary embodiment, each contact wafer 122 has a shield structure 128 for providing electrical shielding for the signal contacts 126. In an exemplary embodiment, the shield structure 128 is electrically connected to the second connector assembly 104 and/or the cables 106. For example, the shield structure 128 may be electrically connected to the second connector assembly 104 by extensions (e.g. beams or fingers) extending from the contact wafers 122 that engage the second connector assembly 104.

The connector housing 120 is manufactured from a dielectric material, such as a plastic material, and provides isolation between the signal contacts 126 from the shield structure 128. The first connector assembly 102 includes a mating end 130 and a cable end 132. In various embodiments, the cable end 132 is opposite the mating end 130, such as with the cables 106 extending from the contact wafers 122 in a direction parallel to the mating axis A. In alternative embodiments, the cable wafers 122 may be right angle cable wafers 122 having the cable end 132 perpendicular to the mating end 130, such as at the top or the bottom. The signal contacts 126 are received in the connector housing 120 and held therein at the mating end 130, such as for mating to the second connector assembly 104. The signal contacts 126 are arranged in a matrix of rows and columns. In the illustrated embodiment, at the mating end 130, the rows are oriented horizontally and the columns are oriented vertically. Other orientations are possible in alternative embodiments. Any number of signal contacts 126 may be provided in the rows and columns.

The second connector assembly 104 includes a connector housing 110 holding contact wafers 112. The connector housing 110 has walls defining a chamber 114 at a mating end of the second connector assembly 104. A mounting end of the second connector assembly 104 is mounted to an electrical component, such as the circuit board 108. Optionally, the mounting end may be substantially perpendicular to the mating end. In the illustrated embodiment, the first connector assembly 102 is coupled to the mating end, such as being received in the chamber 114 through the mating end. The connector housing 120 engages the walls to hold the first connector assembly 102 in the chamber 114.

The second connector assembly 104 includes signal contacts 116 and ground shields 118 extending into the chamber 114. In an exemplary embodiment, the signal contacts 116 are arranged as differential pairs. The ground shields 118 are positioned between the differential pairs to provide electrical shielding between adjacent differential pairs. In the illustrated embodiment, the ground shields 118 are C-shaped and provide shielding on three sides of the pair of signal contacts 116. Other shapes are possible in alternative embodiments. In an exemplary embodiment, each contact wafer 112 includes a signal conditioning module (not shown), which may be similar to the signal conditioning module 300, for conditioning the signals transmitted along the data channels through the second connector assembly 104.

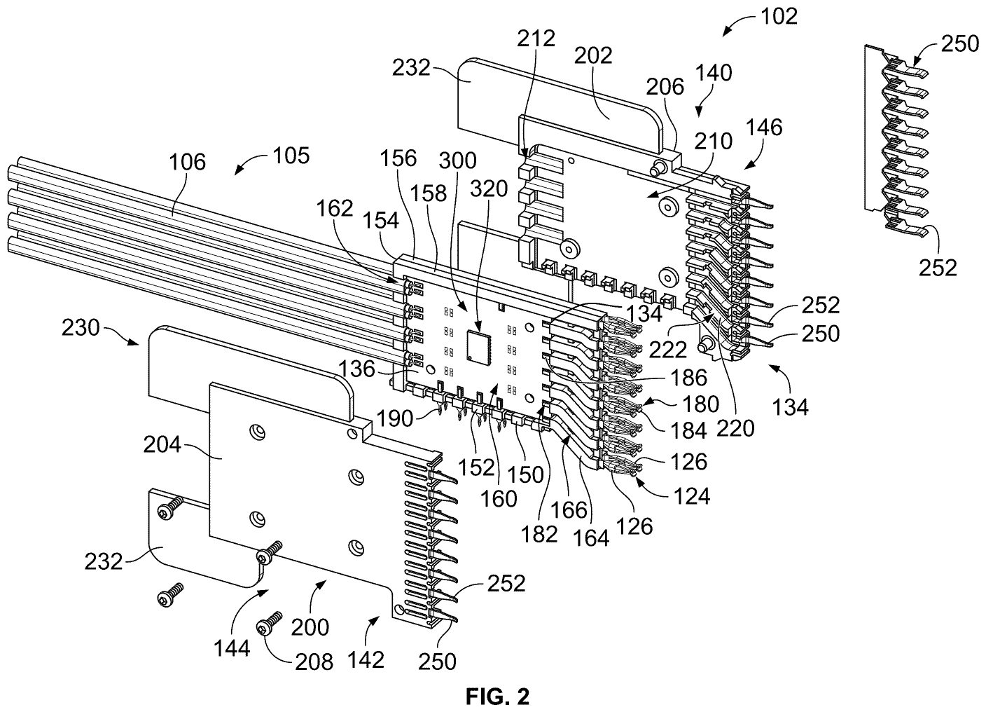

FIG. 2 is an exploded view of one of the contact wafers 122 in accordance with an exemplary embodiment. The contact wafer 122 includes a wafer frame 150, the contact assembly 124 of signal contacts 126 coupled to the wafer frame 150, the signal conditioning module 300 coupled to the wafer frame 150, a cable assembly 105 of a plurality of the cables 106, and a shell 200 surrounding the wafer frame 150 and the signal conditioning module 300. The contact wafer 122 extends between a front 134 and a rear 136. In the illustrated embodiment, the front 134 forms a portion of the mating end 130 and the rear 136 forms a portion of the cable end 132. Other orientations are possible in alternative embodiments. The contact wafer 122 includes a top 140 and a bottom 142. The contact wafer 122 includes a first side 144 and a second side 146. The sides 144, 146 may be generally planar to allow stacking of the contact wafer 122 in the contact wafer stack 121 side-by-side with other contact wafers 122.

With additional reference to FIG. 3, which is an exploded view of a portion of the contact wafer 122 showing the wafer frame 150, the signal contacts 126 and the signal conditioning module 300, the signal contacts 126 are configured to be electrically connected to the signal conditioning module 300. In an exemplary embodiment, the signal contacts 126 are stamped and formed contacts. The signal contacts 126 may be stamped as part of a lead frame, which may be overmolded by an overmold body forming the wafer frame 150. For example, a portion of the signal contact 126 may be overmolded by the wafer frame 150, with portions of the signal contact 126 exposed at opposite ends thereof, such as for electrical connection to the second connector assembly 104 and/or the signal conditioning module 300 and/or the cables 106. In an exemplary embodiment, each signal contact 126 extends between a mating end 180 and a terminating end 182. A transition portion of the signal contact 126 may extend between the mating end 180 and the terminating end 182, which is held by the wafer frame 150.

The mating end 180 is configured to be mated with the corresponding signal contact 116 of the second connector assembly 104 (shown in FIG. 1). For example, the mating end 180 may extend forward of the wafer frame 150. In an exemplary embodiment, the signal contact 126 includes one or more spring beams 184 at the mating end 180. For example, the mating end 180 may include a pair of the spring beams 184 forming a socket or receptacle configured to receive a pin of the signal contacts 116 of the second connector assembly 104. Other types of mating ends may be provided in alternative embodiments. For example, the signal contact 126 may include a pin, a socket, a blade, a tuning fork, or another type of contact interface at the mating end 180.

The terminating end 182 is configured to be terminated to the signal conditioning module 300. For example, the terminating end 182 may extend rearward of the wafer frame 150. In an exemplary embodiment, the terminating end 182 includes a solder tab 186 configured to be soldered to a circuit board or other component of the signal conditioning module 300.

The wafer frame 150 is used to hold the signal contacts 126 and the signal conditioning module 300. The wafer frame 150 positions the signal contacts 126 relative to each other. The wafer frame 150 positions the signal contacts 126 relative to the signal conditioning module 300, such as for terminating the signal contacts 126 to the signal conditioning module 300. The wafer frame 150 may hold ends of the cables 106, such as for termination of the cables 106 to the signal conditioning module 300.

In an exemplary embodiment, the wafer frame 150 is manufactured from a dielectric material, such as a plastic material. The wafer frame 150 includes a dielectric body 152. The dielectric body 152 may be an overmold body, such as being overmolded around portions of the signal contacts 126 and/or portions of the signal conditioning module 300 and/or portions of the cables 106. The wafer frame 150 may be a molded part. In various embodiments, the wafer frame 150 may be a multipiece frame structure, having the pieces assembled together to form the wafer frame 150. For example, the wafer frame 150 may include a first frame member 154 at the first side 144 (FIG. 2) and a second frame member 156 (FIG. 2) at the second side 146. The first frame member 154 and the second frame member 156 form two halves of the wafer frame 150. Each frame member 154, 156 may hold a respective portion of the contact assembly 124. For example, each frame member 154, 156 may be overmolded over a respective lead frame forming a respective column of the signal contacts 126. When the frame members 154, 156 are coupled together, the respective signal contacts 126 are arranged in pairs in rows.

The wafer frame 150 includes outer walls 158 that form a perimeter of the wafer frame 150. For example, the outer walls 158 may include a top wall, a bottom wall, a rear wall, and/or a front wall. The signal conditioning module 300 is held by the outer walls 158. For example, the outer walls 158 may form a pocket 160 that receives the signal conditioning module 300. The pocket 160 may be open at the first and second sides 144, 146 (FIG. 2). The cables 106 (FIG. 2) may pass through cable channels 162 formed in one of the outer walls 158, such as the rear wall.

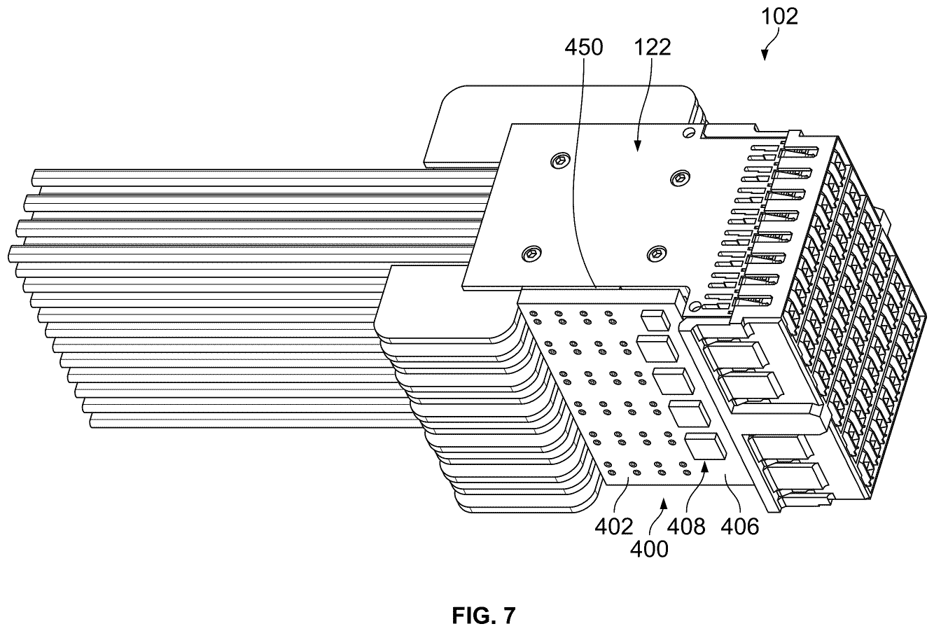

In an exemplary embodiment, the wafer frame 150 may hold distribution contacts 190 in one or more of the outer walls 158, such as the bottom wall. The distribution contacts 190 are configured to be electrically connected to another component, such as a distribution assembly 400 (shown in FIGS. 6 and 7). The distribution contacts 190 may provide power and/or ground and/or data signals between the signal conditioning module 300 and the distribution assembly 400.

In an exemplary embodiment, the wafer frame 150 includes rails 164 holding the corresponding signal contacts 126. The rails 164 are provided at the front 134 (FIG. 2) of the contact wafer 122. For example, the rails 164 extend forward of the pocket 160 and the signal conditioning module 300. The terminating ends 182 of the signal contacts 126 extend from the rails 164 into the pocket 160 for termination to the signal conditioning module 300. The rails 164 may be overmolded around portions of the signal contacts 126. In an exemplary embodiment, the rails 164 are separated by gaps 166, which receive shield elements to provide shielding between the signal contacts 126. For example, portions of the shell 200 may be received in the gaps 166.

With additional reference to FIG. 4, which is a perspective view of a side of the signal conditioning module 300, the signal conditioning module 300 includes a circuit board 302 and one or more active components, such as repeater devices 320, for providing signal conditioning for the data channels of the contact wafer 122. The circuit board 302 includes a first side 304 (FIGS. 2 and 3) and a second side 306 (FIG. 4). The circuit board 302 may include the repeater devices 320 on the first side 304 and/or the second side 306. The circuit board 302 may include other electrical components 308 mounted to the first side 304 and/or the second side 306, such as capacitors, transistors, resistors, memory components, microcontrollers, EEPROM devices, and the like.

The circuit board 302 extends between a front 310 and a rear 312. The circuit board 302 includes a top 314 and a bottom 316. The circuit board 302 includes circuits 318, such as traces, pads, vias, or other types of circuits routed on one or more layers of the circuit board 302. The repeater devices 320 and the electrical components 308 are electrically connected to the corresponding circuit 318. The signal contacts 126 are configured to be electrically connected to the circuit board 302 at the corresponding circuits 318, such as at the front 310. For example, the solder tabs 186 (FIG. 3) may be soldered to pads or other types of circuits 318 of the circuit board 302. The cables 106 are configured to be electrically connected to the circuit board 302 at the corresponding circuits 318, such as at the rear 312. For example, the conductors of the cables 106 may be soldered to pads or other types of circuits 318 of the circuit board 302. In an exemplary embodiment, the signal contacts 126 and/or the cables 106 may be terminated to both sides 304, 306 of the circuit board 302.

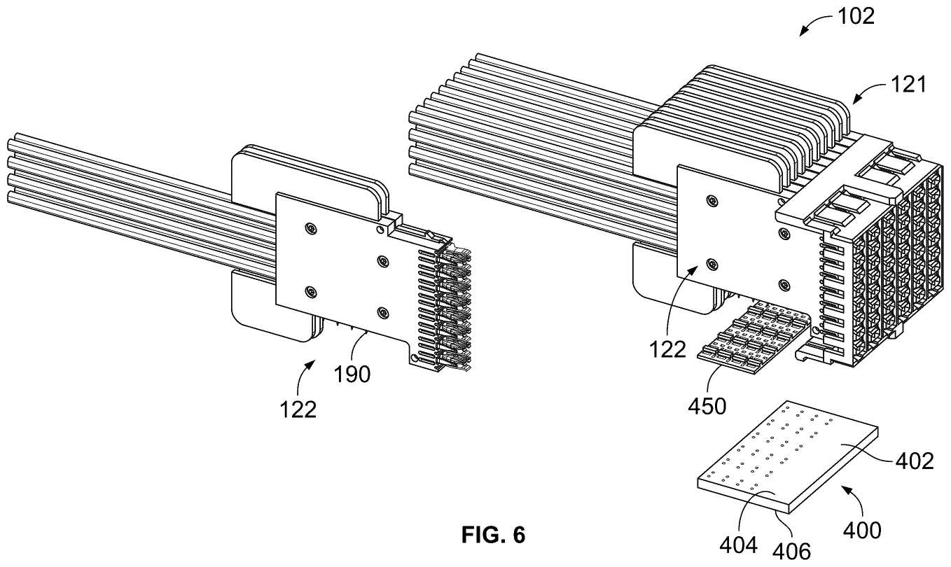

With additional reference to FIG. 5, which is a perspective view of a side of the signal conditioning module 300 showing the cables 106 of the cable assembly 105 configured to be electrically connected to the signal conditioning module 300, each cable 106 includes at least one conductor configured to be electrically connected to the circuit board 302. In an exemplary embodiment, the cables 106 are twin-axial cables each having a pair of conductors configured to be electrically connected to the circuit board 302. The cables 106 may be shielded cables, such as including a cable shield extending the length of the cable 106 and circumferentially surrounding the conductor(s). Other types of cables may be used in alternative embodiments, such as coaxial cables, flat flexible cables, and the like.

The cables 106 are configured to be electrically connected to the corresponding signal contacts 126, such as through the circuit board 302 and the repeater device(s) 320. The cables 106 and the signal contacts 126 form data channels through the circuit board 302 and the repeater devices 320. The repeater devices 320 may be integrated circuits. The repeater device 320 conditions the signals transmitted along the data channels. The repeater device 320 may restore signals transmitted along the data channels. For example, the repeater device 320 may amplify the signals and/or retransmit the signals. The repeater device 320 may condition the signals by providing equalization functions, such as to compensate for jitter and in turn transmit a conditioned signal downstream. The repeater device 320 is placed along the data channels within the contact wafer 122 to allow signal conditioning in-line along the data channels, such as midway between the various electrical components of the communication system. As such, the signal conditioning module 300 operates as a channel reach extension device to extend the transmission line length along the data channels. The repeater device 320 provides reliable, error-free communication for the communication system.

The repeater device(s) 320 are mounted to the circuit board 302, such as to the first side 304 and/or the second side 306. The repeater device 320 may be a re-timer device in various embodiments. In various embodiments, the re-timer device may be an x-16 re-timer device having sixteen channels. The re-timer device is configured to retransmit a fresh copy of the original signal. The re-timer device may be a mixed signal analog/digital device that is protocol-aware and has the ability to fully recover the data, extract the embedded clock and retransmit a fresh copy of the data using a clean clock. The re-timer device may include a continuous time linear equalizer (CTLE) and a wideband gain stage. The re-timer device may include a clock and data recovery (CDR) circuit, a decision feedback equalizer (DFE) and a transmit (Tx) finite impulse response (FIR) driver. The re-timer device may include a finite state machines (FSMs) and/or a microcontroller to manage the automatic adaptation of the CTLE, wideband gain, DFE and FIR driver, and implement a link training and status state machine (LTSSM). The re-timer device may actively participate in the protocol. The re-timer device may fully recover the data stream and retransmit the data signal on a clean clock to enable extension of the channel to twice the original specification. The DFE of the re-timer device compensates for reflections in the channel response caused by impedance discontinuities in board vias, connectors and package socket-board interfaces along the data transmission line. The re-timer device may examine the received signal and adjust the CTLE and DFE to minimize the bit error rate (BER). The transmitter of the re-timer device may adjust de-emphasis and pre-shoot equalization to minimize BER according to equalization protocol. The re-timer device may have tools for assessing the electrical performance (internal eye monitors, pattern generators, pattern checkers) and protocol performance (link state history monitors, timeout adjustments). The re-timer device may compensate and reset any lane-to-lane skew, effectively doubling the specification budget.

The repeater device 320 may be a re-driver device in various embodiments. The re-driver device is configured to amplify the signal that is transmitted downstream of the re-driver device. The re-driver device may be an analog reach extension device designed to boost the high-frequency portions of the signal, such as to counteract frequency-dependent attenuation along the data channel. The re-driver device may include a continuous time linear equalizer (CTLE), a wideband gain stage and a linear driver. The re-driver device may include receive (RX) side equalizer (EQ) to compensate for frequency-dependent attenuation due to PCB traces or cable conductors along the transmission line. The CTLE may function to open the closed eye of the distorted waveform. The transmit (TX) side of the re-driver device may include a pre-emphasis function (transmit equalizer) to pre-shape the transmit waveform.

With reference back to FIG. 2, the shell 200 is used to hold the wafer frame 150 and the signal conditioning module 300. The shell 200 provides a covering for the wafer frame 150. In an exemplary embodiment, the shell 200 includes a conductive body 202. The conductive body 202 may be manufactured from a metal material, such as copper, aluminum, copper alloy, an aluminum alloy, or another metal material. In an exemplary embodiment, the conductive body 202 of the shell 200 is electrically conductive and provides electrical shielding for the signal contacts 126 and the signal conditioning module 300. In an exemplary embodiment, the conductive body 202 of the shell 200 is thermally conductive and is configured to dissipate heat from the signal conditioning module 300. For example, the conductive body 202 of the shell 200 is configured to be thermally coupled to the repeater devices 320 to dissipate heat from the repeater devices 320.

In an exemplary embodiment, the shell 200 is a multipiece structure including a first shell member 204 and a second shell member 206. The first shell member 204 is provided at the first side 144. The second shell member 206 is provided at the second side 146. In an exemplary embodiment, the shell members 204, 206 are coupled together using fasteners 208. The fasteners 208 may pass through the circuit board 302. In an exemplary embodiment, the shell 200 includes a shell cavity 210 between the first shell member 204 and the second shell member 206. The shell cavity 210 receives the contact wafer 122. For example, the contact wafer 122 may be oriented vertically in the shell cavity 210 between the first and second shell members 204, 206. In an exemplary embodiment, the shell 200 includes cable channels 212, such as at the rear 136, that receives the corresponding cables 106.

In an exemplary embodiment, the shell 200 includes separating panels 220 at the front 134. Signal cavities 222 are formed between the separating panels 220. The signal cavities 222 receive the corresponding signal contacts 126. For example, the rails 164 of the wafer frame 150 may be received in the signal cavities 222 between the separating panels 220 the separating panels 220 provide electrical shielding between the signal contacts 126.

In an exemplary embodiment, the shell 200 includes heat transfer elements 230 extending from the shell 200. The heat transfer elements 230 are used for heat dissipation from the shell 200. The heat transfer elements 230 increase the surface area of the shell 200 to increase heat dissipation, such as into the surrounding environment. Airflow over the heat transfer elements 230 may increase heat dissipation from the shell 200. Heat generated by the repeater devices 320 is radiated outward, such as towards the top 140 and/or the bottom 142 and/or the rear 136 to dissipate heat from the repeater device 320.

In an exemplary embodiment, the heat transfer elements 230 include fins 232. The fins 232 may be planar plates extending from the shell 200, such as extending from the top 140 and/or the bottom 142 and/or the sides 144, 146 and/or the rear 136. In the illustrated embodiment, the fins 232 extend generally front to rear to accommodate airflow parallel to the mating axis. The fins 232 may be oriented in other directions in alternative embodiments, such as laterally across the shell 200. In an exemplary embodiment, the fins 232 are provided on both the first shell member 204 and the second shell member 206. The fins 232 may be separated from each other forming an airflow therebetween. Other types of heat transfer elements may be used in alternative embodiments, such as a heatsink or a cold plate. In an exemplary embodiment, the heat transfer elements 230 are integral with the shell 200, such as being diecast or molded with the shell members 204, 206. In alternative embodiments, the heat transfer elements 230 may be separate from the shell 200 and thermally coupled thereto.

The shell 200 forms part of the shield structure 128 of the contact wafer 122. For example, the shell 200 provides electrical shielding for the signal conditioning module 300 and the signal contacts 126. In an exemplary embodiment, the contact wafer 122 includes ground elements 250 extending from the shell 200 along the signal contacts 126. The ground elements 250 are configured to be electrically connected to the mating connector assembly 104. The ground elements 250 provide shielding for the signal contacts 126, such as along the mating ends 180 of the signal contacts 126.

In an exemplary embodiment, the ground elements 250 extend forward from the shell 200. For example, the ground elements 250 may extend from the first shell member 204 and/or the second shell member 206. The ground elements 250 may be provided along both sides of the signal contacts 126. The ground elements 250 may extend between the pairs of signal contacts 126, such as above and/or below each of the signal contacts 126. In an exemplary embodiment, the ground elements 250 are separate and discrete from the shell 200 and coupled to the shell. For example, the ground elements 250 may be stamped and formed ground elements 250. The ground elements 250 may be inserted or stitched into slots or channels formed in the front of the shell 200. In an exemplary embodiment, the ground elements 250 include spring beams 252. The spring beams 252 are deflectable and configured to be spring biased against the mating connector assembly 104.

FIG. 6 is an exploded view of the first connector assembly 102 in accordance with an exemplary embodiment. FIG. 7 is a bottom perspective view of the first connector assembly 102 in accordance with an exemplary embodiment. In an exemplary embodiment, the first connector assembly 102 includes a distribution assembly 400 used to distribute power and/or ground and/or data signals to the signal conditioning modules 300. In an exemplary embodiment, the distribution assembly 400 may be connected to each of the contact waivers 122. In alternative embodiments, a plurality of distribution assemblies 400 may be provided, such as a single distribution assembly 400 for each contact wafer 122.

The distribution assembly 400 includes a circuit board 402 having a first side 404 and a second side 406 distribution assembly 400 includes one or more electrical components 408 mounted to the circuit board 402, such as at the second side 406. In an exemplary embodiment, the first side 404 is a top side of the circuit board 402 and the second side 406 is a bottom side of the circuit board 402. The first side 404 faces the contact waivers 122. For example, the first side 404 may be coupled to the bottom sides of the contact levers 122. The distribution contacts 190 are configured to be electrically connected to the circuit board 402. For example, the distribution contacts 190 may include compliant pins, such as press-fit pins, configured to be press-fit into vias of the circuit board 402.

In an exemplary embodiment, a contact organizer 450 is provided between the distribution assembly 400 and the contact waivers 122. The contact organizer 450 is used to organize the distribution contacts 190 for termination to the circuit board 402. For example, the contact organizer 450 may hold relative positions of the ends of the distribution contacts 190 for loading the pins of the distribution contacts 190 into plated vias of the circuit board 402.

In an exemplary embodiment, the electrical components 408 are provided at the second side 406 of the circuit board 402. The electrical components 408 may be used to control low speed signal distribution to the various contact waivers 122. For example, the electrical components 408 may be used for multiplexing of low speed signals. The electrical components 408 may be used to control power distribution to the various contact waivers 122. For example, the electrical components 408 may be used for power conditioning. The electrical components 408 may include capacitors, transistors, resistors, memory components, microcontrollers, EEPROM devices, power drivers, and the like. In various embodiments, one or more of the electrical components 408 may be a power connector configured to receive power from an external source, such as via a power plug mated with the power connector. In alternative embodiments, the distribution assembly 400 may receive power input and/or control signal input through one or more of the distribution contacts 190, such as via one or more of the contact waivers 122. The power and the control signals may be processed by the electrical components 408 may then be distributed to the other various contact waivers 122.

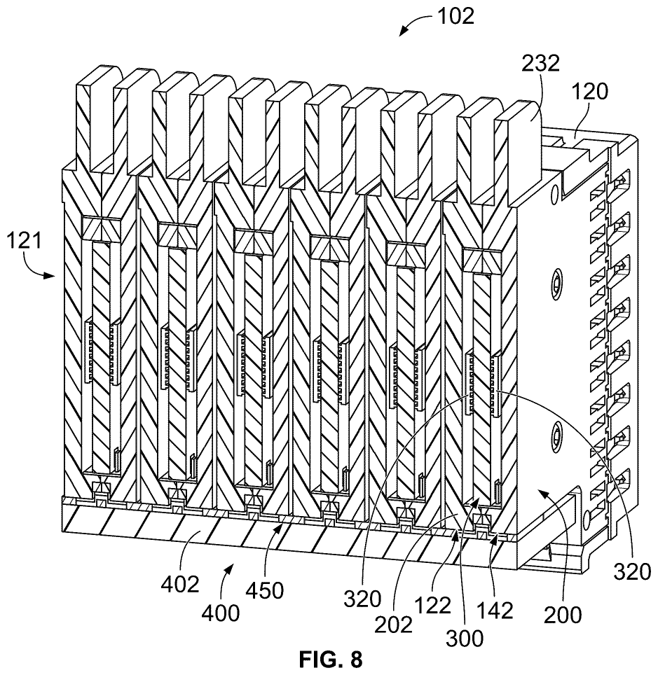

FIG. 8 is a sectional view of the first connector assembly 102 in accordance with an exemplary embodiment. The contact waivers 122 are arranged in the contact wafer stack 121 and received in the connector housing 120. In the illustrated embodiment, the contact waivers 122 are oriented vertically. The contact wafer's 122 are parallel to each other and arranged side-by-side within the contact wafer stack 121. The distribution assembly 400 spans across the bottom 142 to distribute low speed data and power to the contact waivers 122 for control of the signal conditioning modules 300. The contact organizer 450 is located between the circuit board 402 of the distribution assembly 400 and the contact waivers 122.

The shells 200 surrounds the signal conditioning modules 300. The shells 200 provide electrical shielding between the signal conditioning modules 300. The shells 200 are used to extract heat from the repeater devices 320. The shells 200 are manufactured from a thermally conductive material to enhance thermal flow from the active component to the surrounding structures and/or environment. For example, the conductive body 202 of the shell 200 may interface with the repeater device 320 to transfer heat away from the repeater device 320. Optionally, a thermal interface material may be provided between the repeater device 320 and the conductive body 202. The fins 232 have air gaps therebetween to improve heat dissipation away from the shells 200.

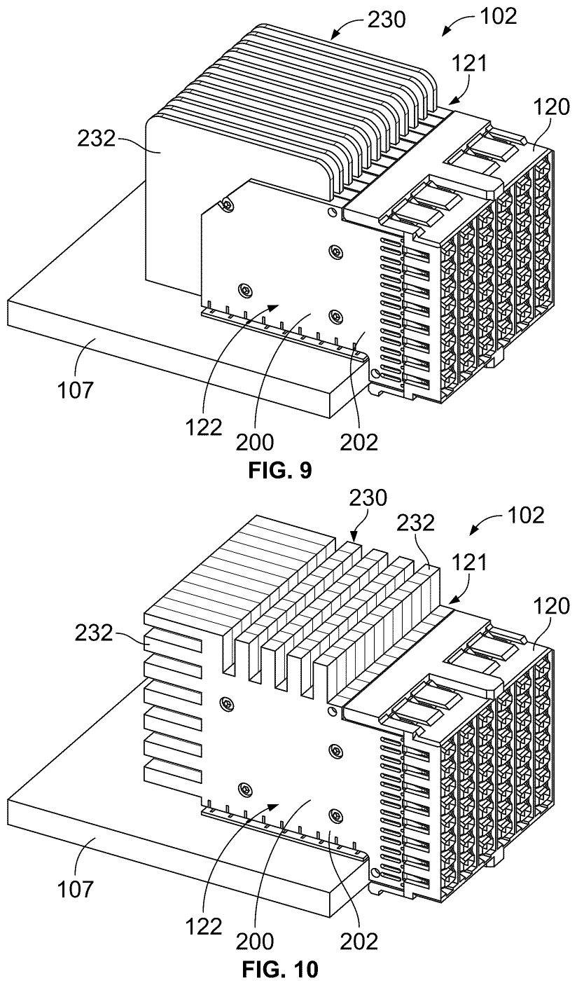

FIGS. 9-13 illustrate the first connector assembly 102 in accordance with an exemplary embodiment, wherein the first connector assembly 102 is a board mounted connector assembly rather than a cable connector assembly. Like components are identified with like reference numerals. The first connector assembly 102 is configured to be mounted to a circuit board 107. The circuit board 107 operates as the distribution assembly to distribute power and/or low speed data to the contact waivers 122. The signal channels of the contact waivers 122 are routed into the circuit board 107 rather than being routed along the cables 106 (shown in FIG. 1).

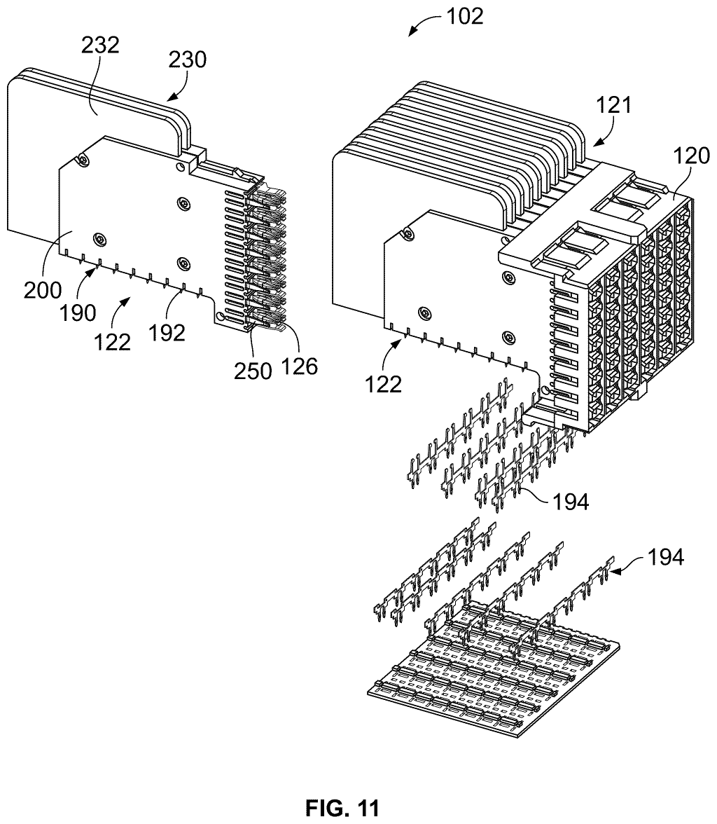

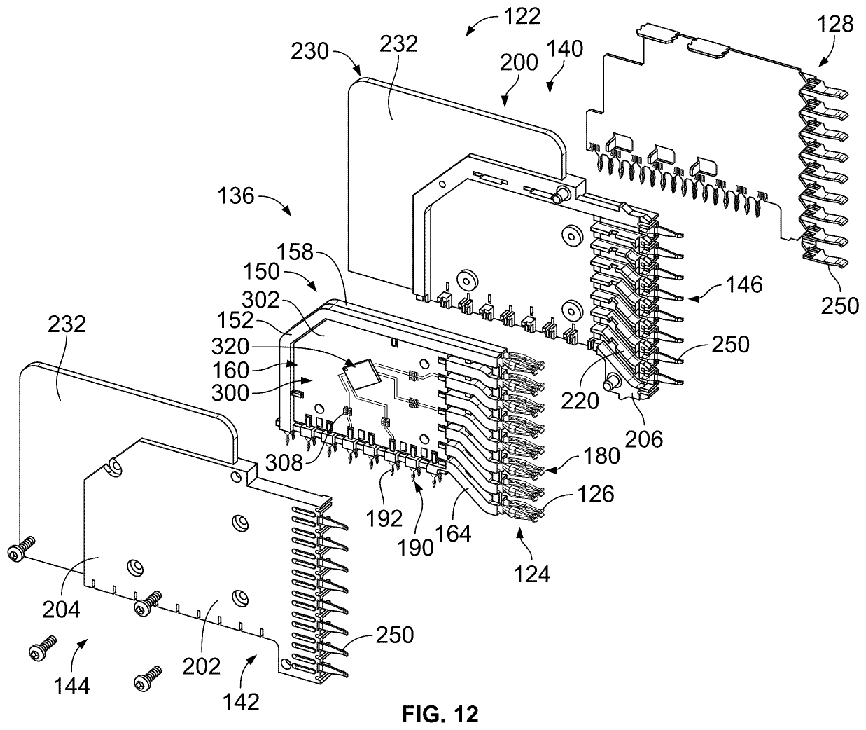

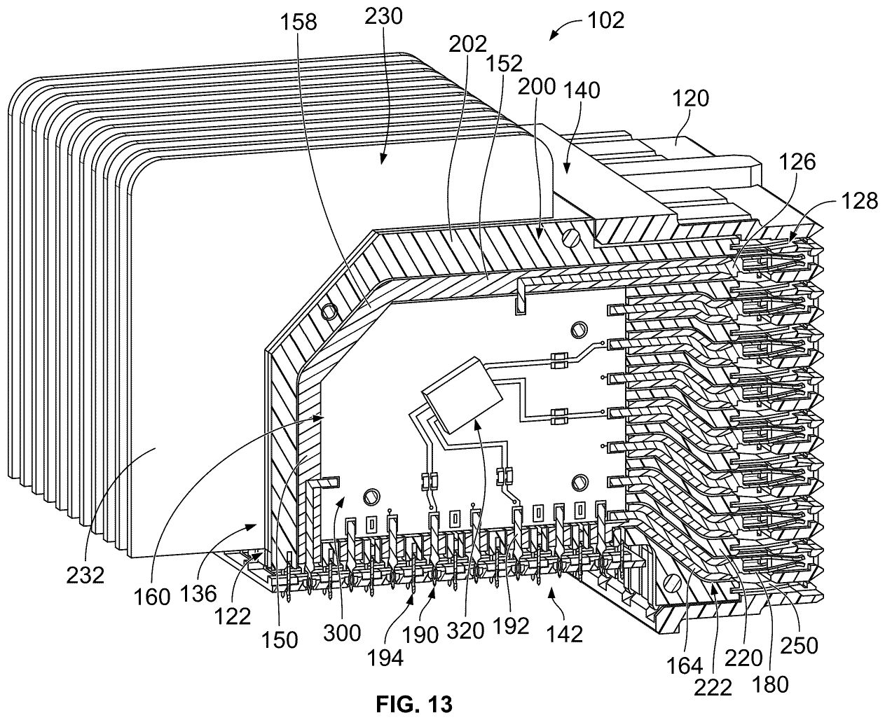

FIG. 9 is a front perspective view of the first connector assembly 102 in accordance with an exemplary embodiment showing a first arrangement of the heat transfer elements 230. FIG. 10 is a front perspective view of the first connector assembly 102 in accordance with an exemplary embodiment showing a second arrangement of the heat transfer elements 230. FIG. 11 is an exploded view of the first connector assembly 102 in accordance with an exemplary embodiment showing 1 of the contact waivers 122 poised for loading into the connector housing 120 and showing the ground contacts configured to be electrically connected to the contact waivers 122 and the circuit board 107. FIG. 12 is an exploded view of 1 of the contact waivers 122 configured to be connected to the circuit board 107. FIG. 13 is a rear perspective, partial sectional view of the first connector assembly 102 in accordance with an exemplary embodiment.

The first connector assembly 102 includes the connector housing 120 that holds a plurality of the contact wafers 122 arranged in a contact wafer stack 121. Each of the contact wafers are configured to be coupled to the circuit board 107. The contact wafer 122 includes the wafer frame 150, the contact assembly 124 of signal contacts 126 coupled to the wafer frame 150, the signal conditioning module 300 coupled to the wafer frame 150, and the shell 200 surrounding the wafer frame 150 and the signal conditioning module 300.

The wafer frame 150 includes the dielectric body 152, such as an overmold body, that holds the signal contacts 126 and the signal conditioning module 300. For example, the outer walls 158 form a perimeter of the wafer frame 150 surrounding the pocket 160 that receives the signal conditioning module 300. The signal contacts 126 are held in the rails 164 at the front. The distribution contacts are held in the outer wall 158 at the bottom. The distribution contacts 190 may provide power and/or ground and/or data signals between the signal conditioning module 300 and the circuit board 107. In an exemplary embodiment, the distribution contacts 190 at the bottom of the wafer frame 150 include termination contacts 192 for electrical connection to the circuit board 107 for transmitting signals between the circuit board 302 and the circuit board 107. The termination contacts 192 are electrically connected to the corresponding signal contacts 126 via the circuit board 302 and the repeater devices 320. The data channels are provided by the signal contacts 126 and the termination contacts 192 through circuits of the circuit board 302 and the repeater device 320. In an exemplary embodiment, the distribution contacts 190 of the wafer frame 150 include ground contacts 194 for electrical connection to the circuit board 107. The ground contacts 194 may be held in one or more of the outer walls 158, such as the bottom wall.

The signal conditioning module 300 includes the circuit board 302 and the repeater device(s) 320 for providing signal conditioning for the data channels of the contact wafer 122. The circuit board 302 may include other electrical components 308, such as capacitors, transistors, resistors, memory components, microcontrollers, EEPROM devices, and the like.

The shell 200 holds hold the wafer frame 150 and the signal conditioning module 300, such as between the shell members 204, 206. The conductive body 202 of the shell 200 is electrically conductive to provide electrical shielding for the signal contacts 126 and the signal conditioning module 300. The conductive body 202 of the shell 200 is thermally conductive to dissipate heat from the signal conditioning module 300, such as from the repeater devices 320. The heat transfer elements 230 are used for heat dissipation from the shell 200. The fins 232 may be planar plates extending from the shell 200, such as extending from the top 140 and/or the bottom 142 and/or the sides 144, 146 and/or the rear 136. The fins 232 may extend generally front to rear (FIG. 9) to accommodate airflow parallel to the mating axis. The fins 232 may be oriented in other directions in alternative embodiments, such as laterally (FIG. 10) across the shell 200.

The shell 200 forms part of the shield structure 128 of the contact wafer 122. For example, the shell 200 provides electrical shielding for the signal conditioning module 300 and the signal contacts 126. For example, the separating panels 220 may be located between the pairs of signal contacts 126. The ground elements 250 extending from the shell 200 along the mating ends 180 of the signal contacts 126.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical connector assembly comprising:
a connector housing having housing walls forming a chamber; and
contact wafers arranged in a contact wafer stack, the contact wafers received in the chamber and coupled to the connector housing, each contact wafer including a wafer frame, a contact assembly coupled to the wafer frame, and a signal conditioning module coupled to the wafer frame;
the signal conditioning module including a circuit board and a repeater device mounted to the circuit board;
the contact assembly including signal contacts forming data channels, the signal contacts having mating ends and terminating ends, the mating ends configured to be mated to mating contacts of a mating connector assembly, the terminating ends being electrically connected to the circuit board of the signal conditioning module, the data channels being electrically connected to the repeater device through the circuit board;
wherein the repeater device is configured to restore signals transmitted along the data channels.

2. The electrical connector assembly of claim 1, wherein the repeater device is a re-timer device.

3. The electrical connector assembly of claim 1, wherein the circuit boards of the signal conditioning modules of the contact wafers are arranged parallel to each other in the contact wafer stack.

4. The electrical connector assembly of claim 1, wherein the signal contacts are arranged in pairs, the signal contacts of each pair terminated to opposite sides of the circuit board.

5. The electrical connector assembly of claim 1, wherein the wafer frame includes a pocket, the signal conditioning module being received in the pocket.

6. The electrical connector assembly of claim 1, wherein the contact wafer includes shield elements extending along the signal contacts providing electrical shielding for the signal contacts.

7. The electrical connector assembly of claim 1, wherein the wafer frame includes a dielectric body holding the signal contacts relative to each other and relative to the circuit board.

8. The electrical connector assembly of claim 1, wherein each contact wafer includes a cable assembly terminated to the signal conditioning module, the cable assembly including cables terminated to the circuit board, the cables being electrically connected to the corresponding signal contacts through the repeater device.

9. The electrical connector assembly of claim 8, wherein the wafer frame includes cable channels receiving the cables.

10. The electrical connector assembly of claim 8, wherein the contact wafer extends between a front and a rear, the signal contacts provided at the front, the cables extending from the rear.

11. The electrical connector assembly of claim 1, wherein each contact wafer includes a shell surrounding the wafer frame and the signal conditioning module, the shell being thermally conductive, the shell being thermally coupled to the repeater device to dissipate heat from the repeater device.

12. The electrical connector assembly of claim 11, wherein the shell includes a first shell member and a second shell member coupled to the first shell member, the shell having a shell cavity between the first shell member and the second shell member, the wafer frame and the signal conditioning module received in the shell cavity.

13. The electrical connector assembly of claim 11, wherein the shell is electrically conductive to provide electrical shielding for the contact assembly and the signal conditioning module.

14. The electrical connector assembly of claim 11, wherein the shell includes ground elements extending from the shell along the signal contacts, the ground elements configured to be electrically connected to the mating electrical connector.

15. The electrical connector assembly of claim 11, wherein the shell includes heat transfer elements to dissipate heat from the shell.

16. The electrical connector assembly of claim 11, wherein the repeater device includes a chip, the shell being thermally coupled to the chip.

17. The electrical connector assembly of claim 1, further comprising a distribution assembly coupled to the signal conditioning modules of each of the contact wafers, the distribution assembly distributing power to the repeater devices of the signal conditioning modules.

18. The electrical connector assembly of claim 17, wherein the distribution assembly includes a distribution circuit board extending below the contact wafer stack, the signal conditioning modules including distribution contacts extending from the circuit boards of the signal conditioning modules, the distribution contacts terminated to the distribution circuit board.

19. An electrical connector assembly comprising:
a connector housing having housing walls forming a chamber; and
contact wafers arranged in a contact wafer stack, the contact wafers received in the chamber and coupled to the connector housing, each contact wafer including a wafer frame, a contact assembly coupled to the wafer frame, a signal conditioning module coupled to the wafer frame, and a cable assembly terminated to the signal conditioning module, wherein the contact assembly is electrically connected to the cable assembly through the signal conditioning module;
the signal conditioning module including a circuit board and a repeater device mounted to the circuit board;
the contact assembly including signal contacts, the signal contacts having mating ends and terminating ends, the mating ends configured to be mated to mating contacts of a mating connector assembly, the terminating ends being electrically connected to the circuit board of the signal conditioning module, the signal contacts being electrically connected to the repeater device through the circuit board;
the cable assembly including cables terminated to the circuit board, the cables being electrically connected to the repeater device through the circuit board;
wherein the cables and the corresponding signal contacts form data channels, the repeater device is configured to restore signals transmitted along the data channels.

20. The electrical connector assembly of claim 19, wherein the wafer frame includes cable channels receiving the cables.

21. The electrical connector assembly of claim 19, wherein the contact wafer extends between a front and a rear, the signal contacts provided at the front, the cables extending from the rear.

22. An electrical connector assembly comprising:
a connector housing having housing walls forming a chamber; and
contact wafers arranged in a contact wafer stack, the contact wafers received in the chamber and coupled to the connector housing, each contact wafer including a wafer frame, a contact assembly coupled to the wafer frame, a signal conditioning module coupled to the wafer frame, and a shell surrounding the wafer frame and the signal conditioning module;
the signal conditioning module including a circuit board and a repeater device mounted to the circuit board;
the contact assembly including signal contacts forming data channels, the signal contacts having mating ends and terminating ends, the mating ends configured to be mated to mating contacts of a mating connector assembly, the terminating ends being electrically connected to the circuit board of the signal conditioning module, the data channels being electrically connected to the repeater device through the circuit board, wherein the repeater device is configured to restore signals transmitted along the data channels;
the shell being thermally conductive, the shell being thermally coupled to the repeater device to dissipate heat from the repeater device.

23. The electrical connector assembly of claim 22, wherein the shell includes a first shell member and a second shell member coupled to the first shell member, the shell having a shell cavity between the first shell member and the second shell member, the wafer frame and the signal conditioning module received in the shell cavity.

24. The electrical connector assembly of claim 22, wherein the shell is electrically conductive to provide electrical shielding for the contact assembly and the signal conditioning module.

25. The electrical connector assembly of claim 22, wherein the shell includes ground elements extending from the shell along the signal contacts, the ground elements configured to be electrically connected to the mating electrical connector.

26. The electrical connector assembly of claim 22, wherein the shell includes heat transfer elements to dissipate heat from the shell.

27. The electrical connector assembly of claim 22, wherein the repeater device includes a chip, the shell being thermally coupled to the chip.
